(19) United States
(12) Patent Application Publication
(10) Pub. No.: US 2001/0034165 A1
(43) Pub. Date: Oct. 25, 2001

(54) Terminal block connector

(76) Inventors: John M. Landis, Camp Hill, PA (US); David J. Fabian, Mount Joy, PA (US)

Correspondence Address: Tyco Technology Resources, Suite 450, 4550 New Linden Hill Road, Wilmington, DE, 19808-2952, US

(21) Appl. No.: 09/792,180

(22) Filed: Feb. 23, 2001

Related U.S. Application Data
(60) Provisional application No. 60/188,485, filed on Mar. 10, 2000.

(51) Int. Cl. H01R 9/26

(52) U.S. Cl. 439/716

(57) ABSTRACT

An electrical connector (30) includes a housing having a conductor receiving face (34) and a mating face (58); an array of terminals (80) disposed in respective terminal receiving passageways, the array including at least one selected terminal; a circuit board (66) disposed intermediate the conductor receiving and mating faces (34, 58) and intersecting at least the passageway in which the selected terminal (80) is disposed; and at least one electrical device (102) mounted to the circuit board (66) spaced from the array of terminals (80). The device (102) is electrically connected by a circuit in the circuit board (66) to the at least one selected terminal (80).

### FIELD OF THE INVENTION

The present invention is directed to electrical connectors and more particularly to terminal block connectors.

### BACKGROUND OF THE INVENTION

It is well known in the art to use a plurality of electronic input/output modules that fit together in a stacked arrangement and are electrically connected together. It is also known that the modules may be mounted to a U-shaped metal rail that supports the device and provides electrical connection to ground. One such arrangement is disclosed in Provisional U.S. patent application Ser. No. 60/129,159, which includes modules that are mated to terminal block connectors.

In some instances, it is desirable to enhance the capability of the terminal block connector to provide selective shunting, to interconnect or common two or more ground conductors, to provide a power bus, or to add additional electronic components to one or more of the lines in the connector. One current way to accomplish the above result is to customize a terminal block connector by using a plurality of discrete terminals, each shaped for a specific position in the connector housing.

It is desirable, however, to enhance the capability of the terminal block connector without having to make a number of different terminals for each connector and without having to redesign a complete modular system.

### SUMMARY OF THE INVENTION

The present invention is directed to a terminal block connector that provides the desired enhancements while eliminating the need to redesign a complete modular system. For purposes of illustration, the present invention will be described in a terminal block connector that is suitable for use in the system described in the aforementioned provisional patent application.

The connector includes a housing having a conductor receiving face and a mating face; an array of terminals, each disposed in a respective terminal receiving passageway extending between the conductor receiving and mating faces, the array including at least one selected terminal; a circuit board disposed intermediate the conductor receiving and mating faces and intersecting at least the passageway in which the at least one selected terminal is disposed, the circuit board including at least one circuit electrically connected to the selected terminal; and at least one electrical device mounted to the circuit board spaced from the array of terminals, the device being electrically connected to the at least one selected terminal. For purposes of this application, the term “electrical device” is to be understood to include electrical terminals and electronic components such as thermistors, capacitors, resistors, or the like, as known in the art.

In the illustrated embodiment the housing includes upper and lower sections secured together with the circuit board extending between them and intersecting all the terminal receiving passageways. It is to be understood that the circuit board does not need to extend along the entire length of the housings.

It is an object of the invention to provide an enhanced terminal block connector that allows the user to program a modular system by selecting either a standard terminal block connector or an enhanced terminal block connector.

It is a further object of the invention to provide an enhanced terminal block connector that has a minimum of different parts and is cost effective to manufacture.

Embodiments of the invention will now be described by way of example with reference to the accompanying drawings.

### BRIEF DESCRIPTION OF THE DRAWINGS

FIG. 1 is an isometric partially exploded view of a modular electrical system using a terminal block connector made in accordance with the present invention.

FIG. 2 is an isometric view of the terminal block connector of the present invention.

FIG. 3 is an isometric exploded view of one embodiment of the terminal block connector of the present invention.

FIG. 4 is a partially sectioned view of the assembled terminal block connector of FIG. 3.

FIG. 5 is an exploded isometric view of another embodiment of the terminal block connector of the present invention.

FIG. 6 is an isometric view of an alternate embodiment of a circuit board used in the terminal block connector of the present invention.

FIG. 7 is an isometric view of another alternative embodiment of the circuit board used in the terminal block connector of the present invention.

### DETAILED DESCRIPTION OF EMBODIMENTS OF THE INVENTION

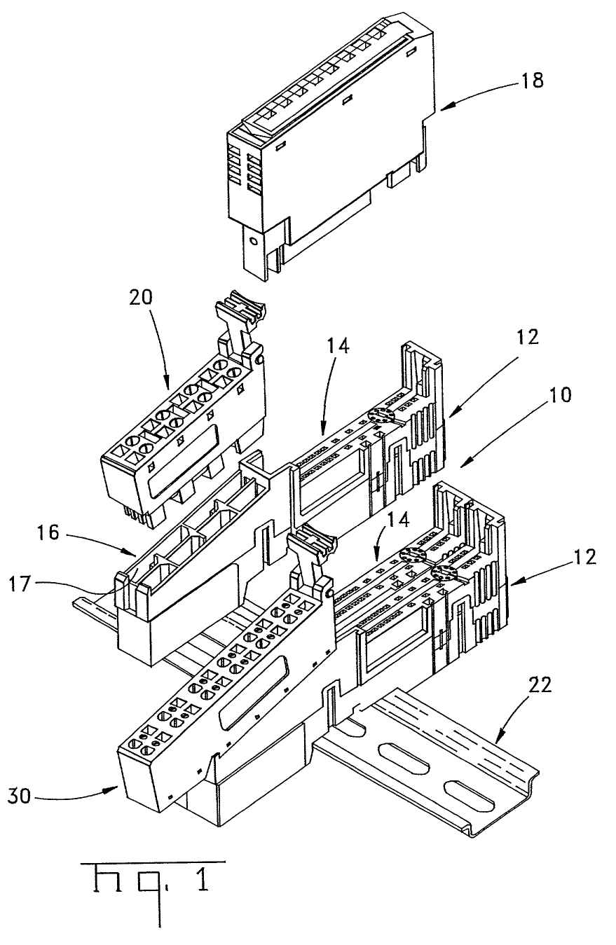

FIG. 1 illustrates a modular input/output system 10 including a pair of input/output modules 12 mounted to rail 22 and another module 12 exploded from the rail 22. Each module 12 has a first portion 14 adapted to mate with a connector 18 and a second portion 16 adapted to mate with a terminal block connector 20, 30. One of the modules 12 is mated to an enhanced terminal block connector 30 made in accordance with the invention and another module is shown with a standard terminal block connector 20. Enhanced terminal block connector 30 is configured to have the same height, width, and mating interface as the standard terminal block connector 20 and is interchangeable therewith. The enhanced terminal block connector 30, however, is longer than the standard terminal block connector 20 and extends beyond the end wall of portion 16 of module 12.

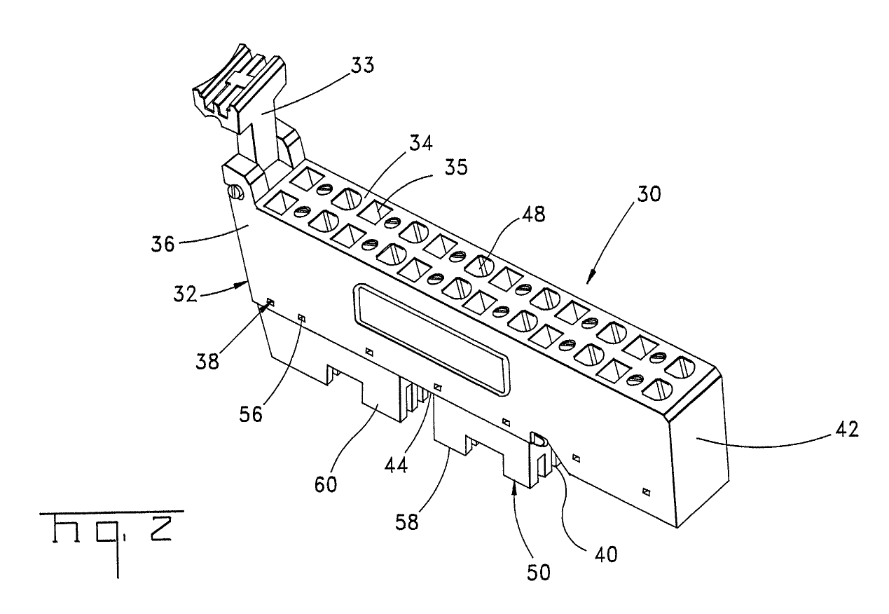

Referring now to FIGS. 1 through 4, the enhanced terminal block connector 30 includes upper and lower housings 32, 50; a circuit board 66 disposed intermediate the upper and lower housings 32, 50, a plurality of terminals 80 having first connecting portions 82 and second connecting portions 90, and a plurality of electrical devices 102 mounted to the circuit board 66 and electrically connected to selected ones of the terminals 80 via the circuit board. For purposes of illustration, the electrical devices are shown as terminals that are identical to first connecting portions 82 of terminals 80. It is to be understood that devices 102 may be other terminals, or components such as thermistors, capacitors, resistors, or the like and combinations thereof.

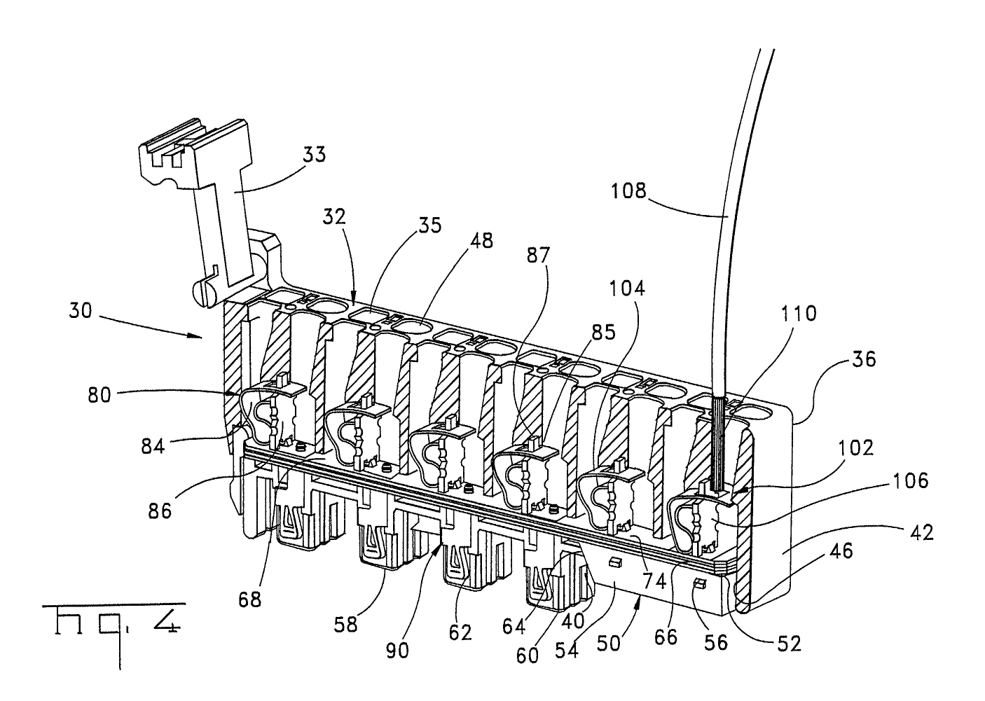

Upper housing 32 includes a conductor receiving face 34, opposed side walls 36, opposed end walls 42 and assembly face 44 and a plurality of terminal receiving passageways 48 extending between faces 34 and 44. Side walls 36 include a plurality of latch receiving apertures 38 for securing upper and lower housings 32, 50 together. Side walls 36 and end walls 42 define a recess 46, shown in FIG. 4, for receiving circuit board 66 and portions of lower housing 50 such that the assembled terminal block connector 30 is the same height as terminal block connector 20. Housing 32 includes a plurality of tool receiving passageways 35 extending into the housing from conductor receiving face 34. Upper housing 32 further includes locking handle 33 used to secure terminal block connector to connector 18 in assembly 10.

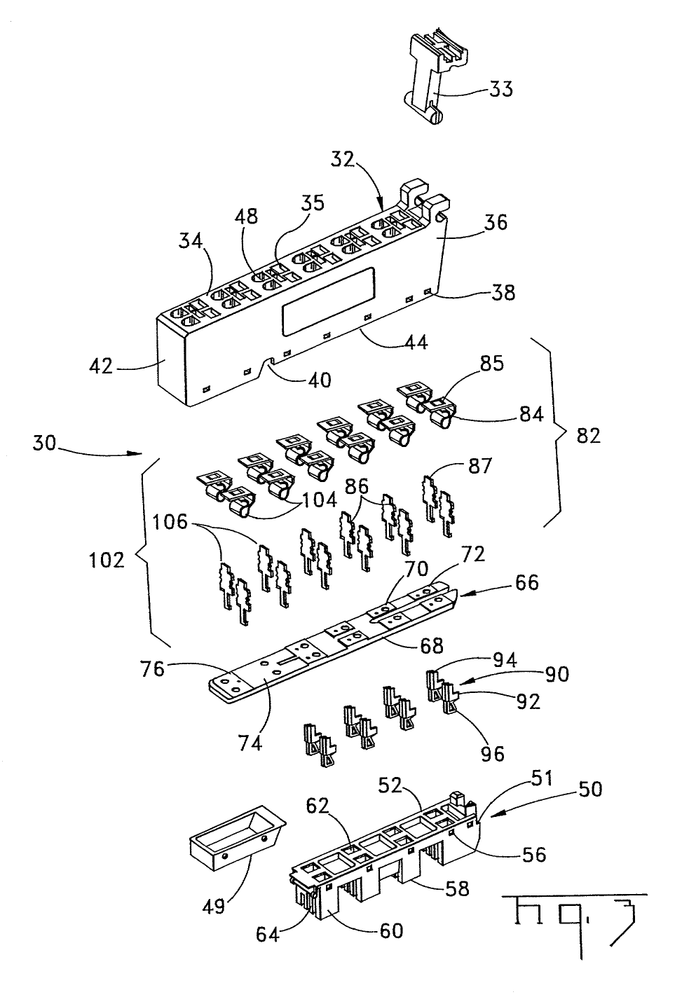

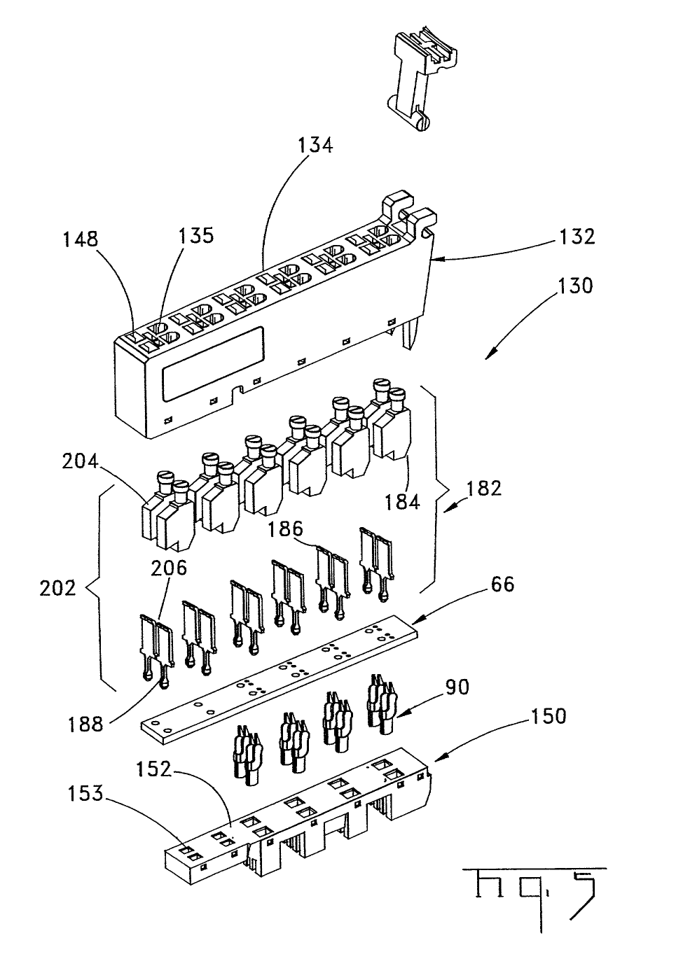

Lower housing 50 includes circuit board engaging face 52, opposed side walls 54, opposed end walls 57, mating face 58, and a plurality of terminal receiving passageways 62 extending between faces 52 and 58. Terminal receiving passageways 62 extend through respective silos extending outwardly therefrom and dimensioned to be received in mating cavities 17 of portion 16 of module 12 shown in FIG. 1. Side walls 54 include a plurality of latching protrusions 56 adapted to be received in latch receiving apertures 38 when terminal block connector 30 is assembled. For ease of molding lower housing So may be made from two pieces 49, 51, as shown in FIGS. 3 and 4, or as a single piece, as shown in FIG. 5.

Circuit board 66 includes first and second portions 68 and 74. First portion 68 has a plurality of apertures 70 and 72 and circuitry (not shown) for interconnecting first connecting portions 82 of terminals 80 with second connecting portions 90. Second portion 74 includes a plurality of apertures 76 and circuitry (not shown) for interconnecting electrical devices 102 to selected ones of terminals 80, as more fully explained below. It is to be recognized that the configuration of circuit board 66 is not limited to using apertures and that circuit pads may be used at some or all of the locations of apertures 70, 72 and 76 if surface mountable terminals and electrical devices are used.

First connecting sections 82 of terminals 80 include springs 84 and tabs 86 that are securable together as shown in FIG. 4. Each tab 86 includes a leg 88 extending downwardly therefrom and dimensioned to be received in a respective aperture 70 of circuit board 66 and a leading portion 87 for being received in conductor receiving slot 85 of spring 84. Second connecting sections 90 of terminals 80 include a body 92 having a circuit board engaging leg 94 dimensioned to be received in a respective aperture 72 of circuit board 66 and a mating portion 96 adapted to be mated to a respective terminal (not shown) in portion 16 of module 12. As can be seen from FIGS. 3 and 4, the terminals 80 are positioned on the first portion of circuit board 66 such that there is no change in the mating face of enhanced terminal block connector 30 with respect to standard terminal block connector 20. As can also be seen from FIGS. 3 and 4, card receiving face 52 of lower housing 50 is longer than mating face 58 to accommodate the second portion 74 of circuit board 66 and the electrical devices 102 mounted thereto. The electrical devices are connected to selected ones of the terminals 80 by circuitry (not shown) in circuit board 66. In the embodiment as illustrated, additional conductors may be terminated to devices 102 and interconnected or commoned with selected conductors 108 that have been terminated to selected terminals 80, for example, to common the ground conductors terminated to terminal block connector 30.

Terminal block connector 30 is assembled by mounting the respective terminal portions to circuit board 66, inserting first connecting portions 82 of terminals 80 into respective terminal receiving passageways and positioning board 66 against assembly face 44 of upper housing 32. Lower housing 50 is then positioned over second connecting portions 90, which are inserted into terminal receiving passageways 62 of housing 50. Lower housing 50 is moved against circuit board 66 and secured into position with latch protrusions 56 entering latch receiving apertures 38 of upper housing 32. Housing 50 includes a notch 64 between the mating face 58 and the extended portion of circuit board receiving face that cooperates with notch 40 of upper housing 32 to provide a slot for receiving the end of second portion 16 when terminal block connector 30 is mated to module 12 as best seen in FIG. 1. FIG. 4 illustrates one conductor 108 inserted in the spring portion 104 of electrical device 102 wherein a tool (not shown) is inserted into aperture 35 of terminal block connector 30 to depress the end of spring 104 to permit insertion of a stripped end 110 of conductor 108 into conductor receiving slot 85. Upon removal of the tool spring 84 resiles toward conductor end 110 to secure the conductor 108 in place.

FIG. 5 illustrates another embodiment 130 of the present invention having upper housing 132, a plurality of terminals, which include a first connecting portion 182 having a screw clamp 184 and a spring arm 186 and electrical devices 202 having screw clamp 204 and spring arm 206, circuit board 66 and lower housing 50 as previously described. The conductor receiving face 134, screw-receiving aperture 135 and terminal receiving passageways 148 of housing 132 are configured to receive the terminals described above. This embodiment illustrates a one piece lower housing 150. Circuit board receiving face 152 of lower housing 150 further includes a plurality of recesses 153 to accommodate portions of terminal legs 188 that extend below board 66. The circuit board 66 and second connecting portions 90 of the terminals are substantially identical to those previously described.

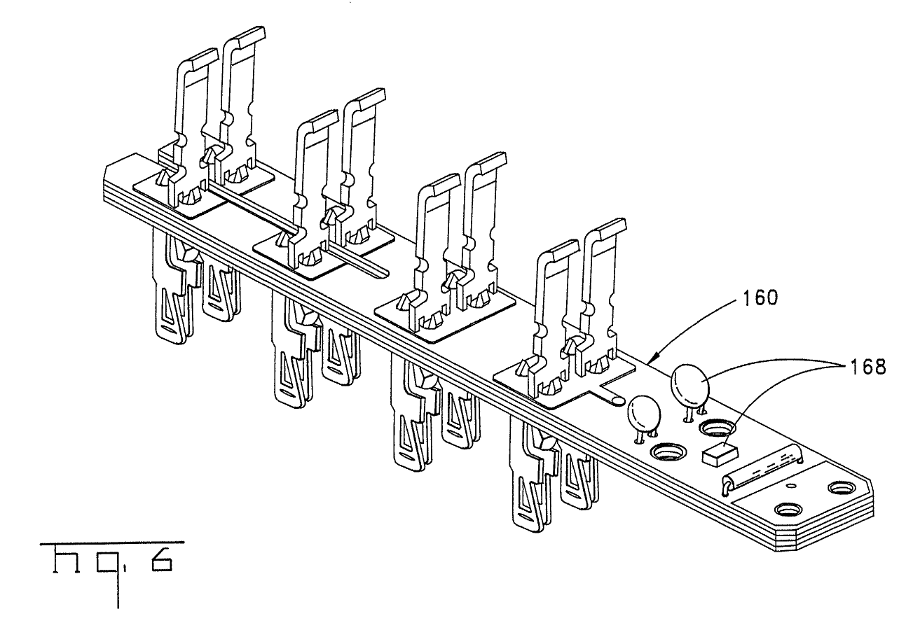

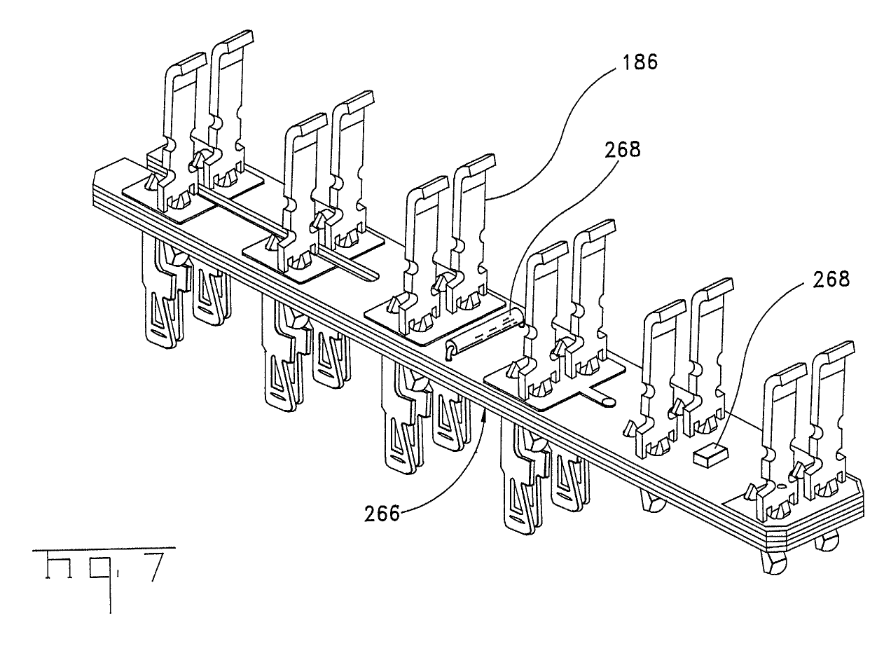

FIGS. 6 and 7 illustrate two other circuit board configurations in accordance with the invention. FIG. 6 illustrates a circuit board 166 having a plurality of electronic components 168 mounted thereto. Components 168 are interconnected to selected terminals in the array of terminals by circuits in the board. FIG. 7 illustrates circuit board 266 having a plurality of electrical devices mounted thereto including both spring arms 186, as shown in FIG. 5, and a plurality of electronic components 268.

The enhanced terminal block connector 30 of the present invention is interchangeable with terminal block connector 20, thus enabling a user to program the input/output modular assembly to meet the needs of the industry. Terminal block connector 30 can be readily configured by changing the circuitry in circuit board 66 to accommodate commoning of a plurality of conductors terminated to the block, and to provide electronic components for selected lines and combinations thereof, without having to redesign a complete input/output assembly. Furthermore, the use of a circuit board eliminates the need to stamp and form a plurality of differently shaped discrete terminals for each customized connector configuration. The connector of the present invention uses identical terminals and relies on the circuitry of the board to achieve the desired electrical capability. The terminal block connector of the present invention is easier to assemble and is more cost effective to manufacture than connectors of the prior art. The connector can be customized by changing the routing of the circuitry in the circuit board while using the same basic housings and terminals. The enhanced module provides a cost effective solution to upgrade and provide greater capability for the system.

It is thought that the enhanced terminal block connector of the present invention and many of its attendant advantages will be understood from the foregoing description. It is apparent that various changes may be made in the form, construction, and arrangement of parts thereof without departing from the spirit or scope of the invention, or sacrificing all of its material advantages.

We claim:

1. An electrical connector comprising:
a housing having a conductor receiving face and a mating face;
an array of terminals disposed in respective terminal receiving passageways extending between the conductor receiving and mating faces, the array including at least one selected terminal;
a circuit board disposed intermediate the conductor receiving and mating faces and intersecting at least the passageway in which the at least one selected terminal is disposed, the circuit board including at least one circuit electrically connected to the at least one selected terminal; and
at least one electrical device mounted to the circuit board spaced from the array of terminals, the device being electrically connected by the at least one circuit to the at least one selected terminal.

2. The electrical connector of claim 1 wherein the at least one electrical device is another electrical terminal spaced from the array of terminals disposed in the passageways such that a conductor terminated to the another terminal may be interconnected to the at least one selected terminal.

3. The electrical connector of claim 1 wherein the electrical device is an electronic component.

4. The electrical connector of claim 1 wherein the circuit board intersects all the terminal receiving passageways.

5. The electrical connector of claim 4 wherein the array of terminals includes a plurality of selected terminals and wherein the circuit board includes a plurality of electrical devices, each device being electrically connected to at least one of the selected terminals.

6. The electrical connector of claim 1 wherein the at least one selected terminal includes separate first and second connecting sections that are electrically connected to each other by additional circuitry in the circuit board.

7. The electrical connector of claim 1 wherein the housing is formed from at least two interlocking parts, an upper housing and a lower housing with the circuit board being secured between the upper and lower housings.

8. The electrical connector of claim 7 wherein the circuit board includes a first portion that intersects all the terminal receiving passageways and a second portion spaced from the passageways.

9. The electrical connector of claim 8 wherein at least all of the selected terminals in the array include a first connecting portion disposed in the upper housing and a second connecting section disposed in the lower housing, the sections being electrically connected to each other by additional circuitry in the circuit board.

10. An electrical connector comprising:
an upper housing having a conductor receiving face;
a lower housing having a mating face, the lower housing being securable to the upper housing;
a circuit board disposed between the upper and lower housings;
an array of electrical terminals disposed in respective terminal receiving passageways, the array including at least one selected terminal; and
at least one electrical device mounted to the circuit board spaced from the array of terminals, the device being electrically connected to the at least one selected terminal by at least one circuit of the circuit board.

11. The electrical connector of claim 10 wherein the at least one electrical device is another electrical terminal spaced from the array of terminals disposed in the passageways such that a conductor terminated to the another terminal may be interconnected to the at least one selected terminal.

12. The electrical connector of claim 10 wherein the at least one electrical device is an electronic component.

13. The electrical connector of claim 10 wherein the at least one selected terminal includes separate first and second connecting sections that are electrically connected to each other by additional circuitry in the circuit board.

14. The electrical connector of claim 10 wherein the array of terminals includes a plurality of selected terminals and wherein the circuit board includes a plurality of electrical devices, each device being electrically connected to at least one of the selected terminals.

15. The electrical connector of claim 14 wherein at least all of the selected terminals in the array include a first connecting portion disposed in the upper housing and a second connecting section disposed in the lower housing, the sections being electrically connected to each other by additional circuitry in the circuit board.
